(19) United States
(12) Patent Application Publication
(10) Pub. No.: US 2021/0241388 A1
(43) Pub. Date: Aug. 5, 2021

(54) Social Mobile Application for Locating Businesses and Users

(71) Applicant: JOYND, Inc., Jackson, CA (US)

(72) Inventor: Lacey Arevalo, Jackson, CA (US)

(73) Assignee: JOYND, Inc., Jackson, CA (US)

(21) Appl. No.: 17/154,089

(22) Filed: Jan. 21, 2021

Related U.S. Application Data
(60) Provisional application No. 62/964,494, filed on Jan. 22, 2020.

(51) Int. Cl. G06Q 50/00; G06Q 20/32; G06Q 30/02; H04W 4/02

(52) U.S. Cl. CPC G06Q 50/01; G06Q 20/3267; H04W 4/02; G06Q 30/0281; G06Q 30/0256

(57) ABSTRACT

A location enabled mobile application that enables personal users to locate businesses based on search criteria such as business type, location, services offered and events. Personal and business users may create a detailed profile with business profiles including business name, business type, location, contact information, images, services offered, promotions, events and detailed service information.

Personal users may search business profiles based on various criteria such as location, business type, services offered, promotions and events. Once results are found, a personal user may view details of the business, communicate directly with the business, book services and various other options depending on the features enabled by the business user.

Personal users may enable social options that allow other personal users to discover them while in close proximity to each other. These social options allow personal users to exchange messages, connect outside the application and send electronic payments to each other.

### PRIORITY CLAIM

This application claims the benefit of priority to U.S. Provisional Application Ser. No. 62/964,4494 filed Jan. 22, 2020, the contents of which are incorporated herein by reference.

### FIELD OF THE INVENTION

The invention claimed in this patent application is directed to mobile applications utilized on smart phones equipped with location based services (GPS) and mobile internet (3G, 4G and 5G). The claimed invention is an application for searching, locating and interacting with businesses and connecting socially through the application with other users. This mobile application is designed to be used differently by two parties: 1) the personal user and 2) the business user. The personal user may create a profile on the application as well as utilize the claimed application to locate particular types of businesses, as well as specific services, specials and events at businesses on the platform. The business may also create a profile that allows promotion of their business through the application by providing business information, images, videos, services, specials and events. Business advertising is enabled as an element of the claimed invention. Another element of the claimed invention is allowing personal users to connect with other personal users proximately located at the same business and send messages, payments and other content.

### BACKGROUND OF THE INVENTION

Internet connected smart phones with GPS location services have enabled development many new applications for locating business, services, content and users by location. Applications that allow personal users to create public profiles including photos, contact information and to share messages or other content are well known in the art. Popular examples of such applications are Facebook, Twitter, Instagram and SnapChat. Applications that allow business users to create business profiles for public searching based on business information are also well known in the art. Personal and business owners are familiar with Yelp and Google as popular examples of these types of services.

The present invention is a novel example of a mobile application leveraging mobile internet and location data to provide useful services to personal and business users alike. The present invention allows personal users to create user profiles containing images, videos, interests, favorite business locations, contact information, connection to other social media accounts and electronic payment information. The claimed application also enables business users to create informational profiles for their businesses including business type, services, address, contact information, images, videos, events, promotions and other promotional business information.

Personal users are then able to search the business profiles based on various criteria such as business type, services offered, location, events, specials/promotions, etc. Business users can utilize advertising campaigns on the platform to promote their businesses and allow personal users to discover their businesses.

The claimed invention also contains a novel feature that allows personals located at the same business establishment to discover each other through the application and connect socially. Personal users can send messages and other communication, as well as electronic payments through standard electronic payment platforms.

### BACKGROUND ART

The existing art related to the present invention includes a number of variations including business and personal profiles, establishing user location using GPS and various combinations thereof. The unique combination of business profiles, personal profiles connected to allow social interaction within a business location with electronic payments is unknown in the present art.

### OBJECTS OF THE INVENTION

It is an object of the invention to provide a mobile application that enables creation of personal user profiles.

It is an object of the invention to provide a mobile application that enables creation of business profiles.

It is an object of the invention to allow personal user profiles to include name, image, videos, contact information and electronic payment addresses.

It is an object of the invention to allow personal user profiles to have messaging capabilities with other personal user profiles and business profiles.

It is an object of the invention to allow business profiles to include business type, service offerings, images, videos, location information, contact information, events, promotions, calendars and detailed service offerings for a given business.

It is an object of the invention to enable personal users to search business profiles based on various criteria including business type, services offered, location, specials and calendared events.

It is an object of the invention to enable personal users to enable social features on their personal user profile.

It is an object of the invention for personal users to be able to send messages and electronic payments to other personal users on the platform.

It is an object of the invention for personal users to be able to book services with a business via an integrated calendar.

It is an object of the invention for a business user to be able to display a live feed of their business to personal users.

### SUMMARY OF THE INVENTION

The claimed invention is a location enabled mobile application that enables personal users to locate businesses based on search criteria such as business type, location, services offered and events. The core of the claimed application is based on two types of profiles: 1) personal user profiles and 2) business profiles.

A personal user may create a profile including their name, image, videos, personal information, contact information and electronic payment information. A business user may create a profile for their business with the business name, business type, location, contact information, hours of operation, images, videos, services offered, promotions, events and detailed service information.

Personal users may search business profiles based on various criteria such as location, business type, services offered, promotions and events. Once results are found, a personal user may view details of the business, communicate directly with the business, book services and various other options depending on the features enabled by the business user.

Further, personal users may enable social options that allow other personal users to discover them while in close proximity to each other, such as when in the same business. These social options allow personal users to exchange messages, connect outside the application and send electronic payments to each other.

Additionally, the claimed invention allows businesses to run advertising campaigns to promote their businesses to personal users. Various options are outlined in the disclosed preferred embodiment but this description is not intended to limit the invention beyond the language of the claims.

### BRIEF DESCRIPTION OF THE DRAWINGS

FIG. 1 shows a block diagram of the system.

FIG. 2 shows the user sign up and login screens.

FIG. 3 shows the user search screens.

FIG. 4 shows various business profile screens.

FIG. 5 shows the social screens for the claimed application.

FIG. 6 shows event screens for a business profile.

FIG. 7 shows social and electronic payment connections via the application.

FIG. 8 shows the business profile setup pages.

FIG. 9 shows business analytics screens for the application.

FIG. 10 shows a flow chart of the personal user flow.

FIG. 11 shows a flow chart of the personal user profile setup.

FIG. 12 shows a flow chart of the business user flow.

FIG. 13 shows a flow chart of the social functions of the platform.

### DETAILED DESCRIPTION OF THE INVENTION

The following detailed description outlines the preferred embodiment of the claimed invention. There may be many other configurations that comport with the attached claim language and this description is in no way limiting to the scope of the invention.

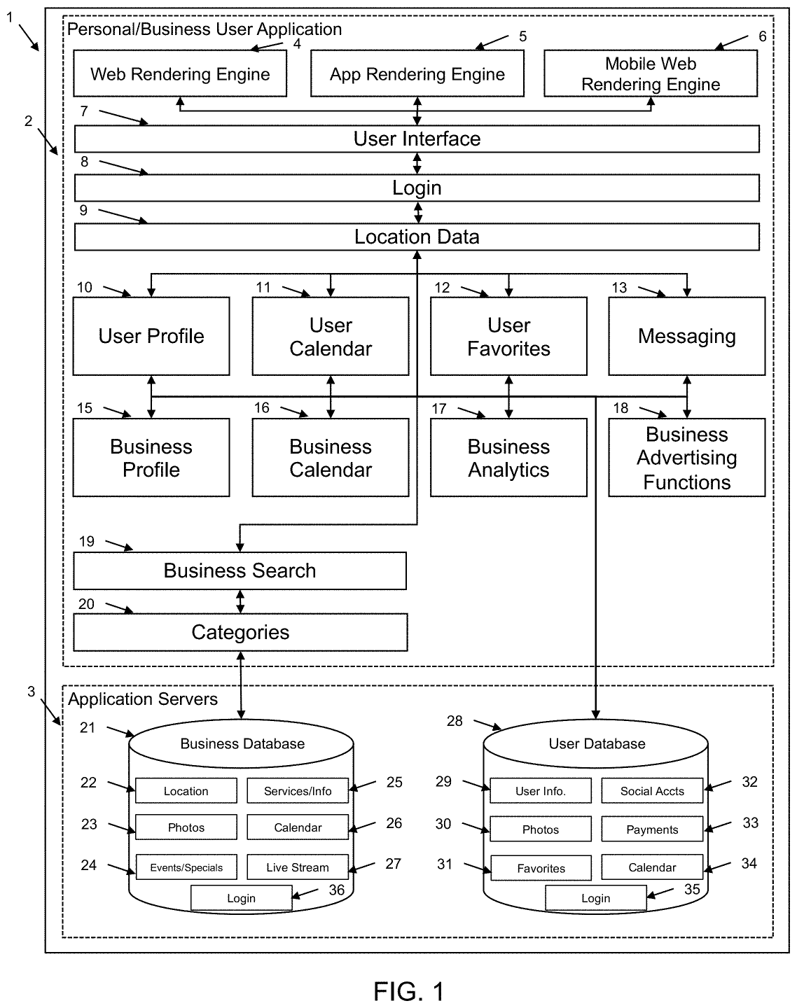

FIG. 1 shows a block diagram of the social mobile application for locating businesses and users system 1 disclosed in the present patent application. They social application system 1 is made up of two parts, personal/business user application 2 and application servers 3. Personal/business user application is downloaded to the application user's mobile device or accessed through the internet either on a mobile device or desktop computer. Application servers 3 store the database content for the system, including business database 21 and user database 28. The application is coded to be compatible with Apple's iOS and Google's Android operating systems but could be developed to be compatible with any existing or future mobile operating system.

In the preferred embodiment of the disclosed invention, personal/business user application is developed in developed in Apple's Swift programming language for developing iOS, macOS and other Apple hardware products. It is anticipated that the disclosed invention could be developed in any suitable programming language such as Objective-C, Rust, Haskell, Ruby, Python, C#, C++, Java, Scala, Kotlin, Go, JavaScript or CLU. User/business application 2 is displayed on the user's screen by the appropriate rendering engine for the user's device, specifically web rendering engine 4 for display on desktop internet browsers (such as Chrome, Safari, Firefox and various Microsoft browsers), app rendering engine 5 for mobile applications (such as Apple iOS and Google Android) and mobile web rendering engine 6 for mobile web browsers (Safari, Chrome, Android native, Opera, etc.). User interface 7 controls display of the application interface, including the business profiles, user profiles, search menu and side menu. Login 8 allows a user to login, for either a personal user profile or a business user profile. Login 8 checks the given username and password against the login information stored in login 35 contained in user database 28 or login 36 stored in business user database 21. Location data 9 is established primarily through Global Positioning System (GPS) latitude and longitude coordinates but can also be provided through address, city/state and/or Zip code data provided by the user.

The present system anticipates two types of users: personal users and business users. Personal users will use the system to locate businesses based on their search criteria (to be described in a later section) and business users utilize the platform to display information for their business User profile 10, user calendar 11, user favorites 12 and messaging 13 are displayed for personal users rather than business users. User profile 10 allows the user to set up their profile with a username, password and photo(s). Other relevant information such as full name and default location are also collected. A user also provides connections to their social accounts such as Facebook, Twitter, Instagram, WhatsApp and other relevant social accounts in user profile 10. These connections can be made manually by providing login information for the specific social account or by using connection APIs provided by the specific social account provider. Also in user profile 10, the user can provide credentials for various electronic payment providers such as Venmo, Cash App, Paypal or any other electronic payment provider the user chooses. As with social accounts, connections to electronic payment accounts can be accessed by manually adding login credentials or by accessing connection APIs provided by electronic payment providers. User calendar 11 stores and displays any appointments or service reservations made by the user as well as any business events added to their calendar by a user. User favorites 12 stores and displays businesses that have been added to a user's favorites list. Messaging 13 allows the user to message other users who have activated the social connection option and have provided access to send and receive messages through the system. Data for user profile 10, user calendar 11 and user favorites 12 is stored in the appropriate location in user database 28 to be described in depth in a later section.

Business profile 15, business calendar 16, business analytics 17 and business advertising functions 18 are displayed in application for business users only. Business profile stores the local profile of the business including name, address/location, category, services, photos and providers. Business calendar 16 saves and displays the local version of the business calendar. Business calendar 16 saves available services and appointments, reservations and events for the business. Business analytics 17 provides performance analytics related to the business including views, keyword searches, favorites, and social interactions at the business. Business advertising functions 18 allows the business to create, start, manage and stop advertising functions for the system. Advertising features include inclusion at top of search results, keyword targeting and other sponsored offers. All of the information stored and displayed locally in the business user application is also stored in business database 21. While these are the functions included in the preferred embodiment, it is anticipated that many other business profile features, analytics and advertising functions could be included in future versions of the system.

Business search 19 includes all the functionality for a personal user to find a business based on their specific search criteria. Such search criteria include name, category, keyword, location, search radius, services offered and reservations available. Business search 19 can utilize the location data provided by location data 9 or the user can input a specific address, neighborhood, city/state and/or zip code. Categories 20 allows the user to sort through the businesses by category and provides categorized business information in a structured format to business search 19 searching.

Application servers 3 include the business database 21 and the user database 28. Business database 21 stores details for all the businesses with business listings that display on the system. This information is stored in a standard database format well known in the art. Location 22 includes the location data for each business. Photos 23 include photos of the business, providers, services offered and other photos uploaded by the business owner. Events/specials 24 includes details about any events or specials offered by the business. Services/info 25 stores information about the specific services offered, provider (hairdressers, etc.) biographies, and other relevant business information. Calendar 26 includes a complete calendar for a business, including reservations, events, calendars for specific providers at the business and appointment availability. Live stream 27 includes live video feeds from businesses that opt to include live stream functionality. Lastly login 36 is a username and password database for business users of the platform. This portion of the platform is encrypted using password encryption technology well known in the art.

User database 28 stores details for personal users of the system. User information 29 stores user details such as name, location and other relevant profile details that are displayed to the user and optionally, other users of the system. Photos 30 stores user profile photos and other photos uploaded to the system by users, such as photos of business locations, services from businesses and other relevant photos. Favorites 31 stores the user's favorite businesses as selected by the user on the business profile. Social accounts 32 includes connections to all the user's shared social accounts such as Facebook, Twitter, Instagram, Whatsapp and other relevant social media accounts. These details could include login details for the social network or connection to the social network through an API provided by the social media provider. Payments 33 include connections to user's electronic payment accounts such as Venmo, Cash App, Paypal and others. As with social media accounts, the details could include login details for the electronic payment providers or connection via provided APIs to the electronic payment providers. Calendar 34 stores appointments/reservations made by the user, as well as events saved from specific business locations. Lastly, login 35 stores login details for all personal user accounts in encrypted format, as with business user logins 36.

Application servers 3 are hosted on hosting providers well known in the art, such as Amazon Web Services (AWS). While AWS hosting is disclosed in this preferred embodiment, any number of other application server hosting arrangements well known in the art are anticipated by this disclosure and claims.

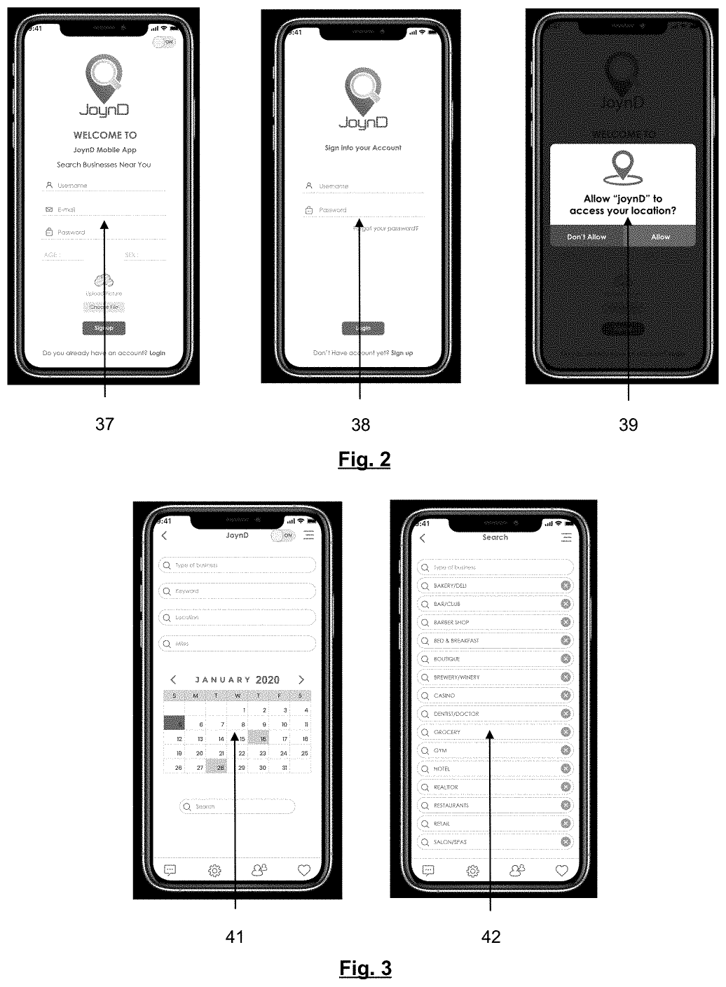

FIG. 2 shows the variety of startup screens for the claimed mobile application. Launch screen 37 shows the initial state of the application after download and installation from the Apple App store, Google Play store, other app store or any other mobile application installation method. Login screen 38 shows the initial state of the application, allowing the user to login to the application using a username and password in the preferred embodiment, though many other login methods including touch, face recognition, encryption key, phone number or any login method known in the art are anticipated to allow login. Location notification screen 39 shows the application asking permission to access the user's GPS location and thus connect to the GPS for the user's mobile device. GPS location is used in the preferred embodiment but other location methods like IP address, zip code, city, state, and various other user or device inputs are anticipated.

FIG. 3 displays the search screens included in the claimed invention. Main search screen 41 shows the variety of options available to search for participating businesses. In the preferred embodiment, these criteria include: type of business, keyword, location, distance and date displayed in a calendar format. These are the options available in the preferred embodiment but the invention is not so limited and other search options could be included in accordance with the claims. Business category screen 42 shows the variety of categories of businesses that are included in the preferred embodiment of the claimed invention including Bakery/Deli, Bar/Club, Barber Shop, Bed & Breakfast, Boutique, Brewery/Winery, Casino, Dentist/Doctor, Grocery, Gym, Hotel, Realtor, Restaurants, Retail and Salon/Spas. Many of the preferred business categories are shown in business category screen 42 but the invention is sufficiently flexible to allow for any conceivable business category to be included.

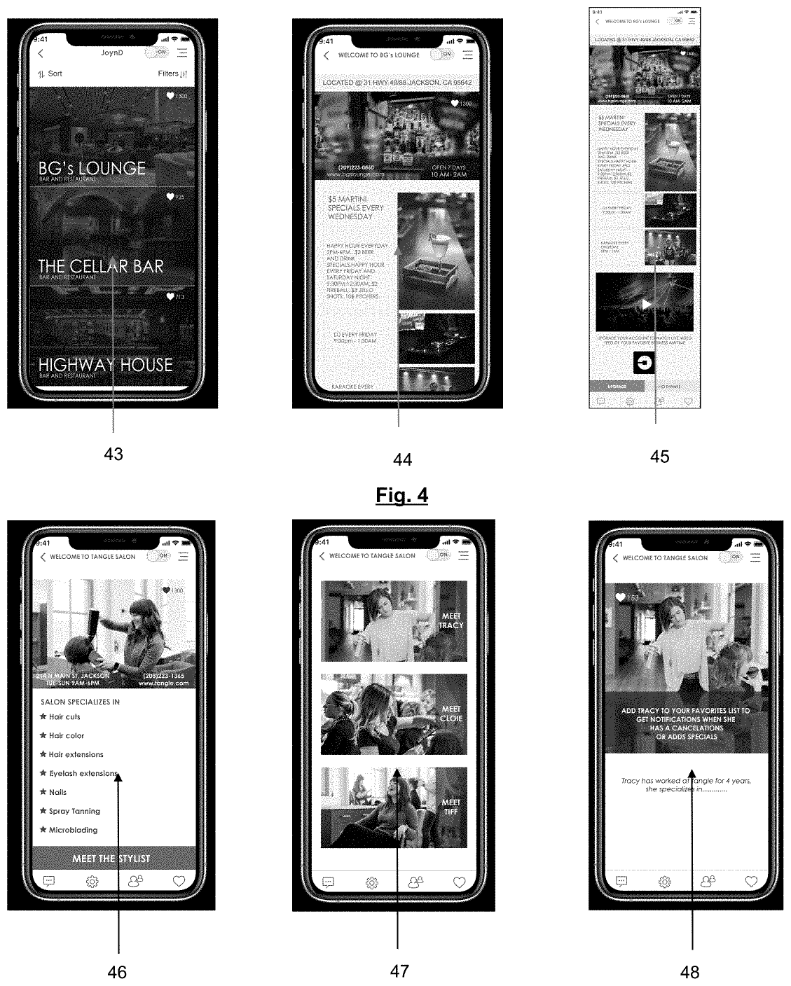

FIG. 4 shows the various business listing pages that result from a user search. Search results 43 show the result of a user search after configuring the options on the main search screen 41. After the user selects their search options, this listing of search results 43 show the businesses that meet their search criteria for business type, keyword, location and event date. Business detail listing 44 shows the view of a specific business after a user taps on a business on the search result 43 screen. Business detail listing 44 includes relevant information about the business including address, phone number, website, hours, specials, events, photos, videos, reviews, likes, special features and other information as configured by the business. Alternate business detail listing 46 shows a different business listing configuration for a hair salon. This listing includes the salon specialties. Expanded business detail listing 46 shows additional details about the business as in this preferred embodiment for a hair salon. In this embodiment, a user can review additional details about specific hair stylists. In other embodiments, Expanded business listings may include any relevant details about the specific service offered. Expanded service detail listing 47 shows more information about the given hair stylist after the user taps the panel in expanded business detail listing 46. While this embodiment shows a hair stylist, this expanded service detail listing 47 can be configured to contain a variety of information about a given business service. Live feed screen 45 shows a live video feed from the business location if the business chooses to enable this option.

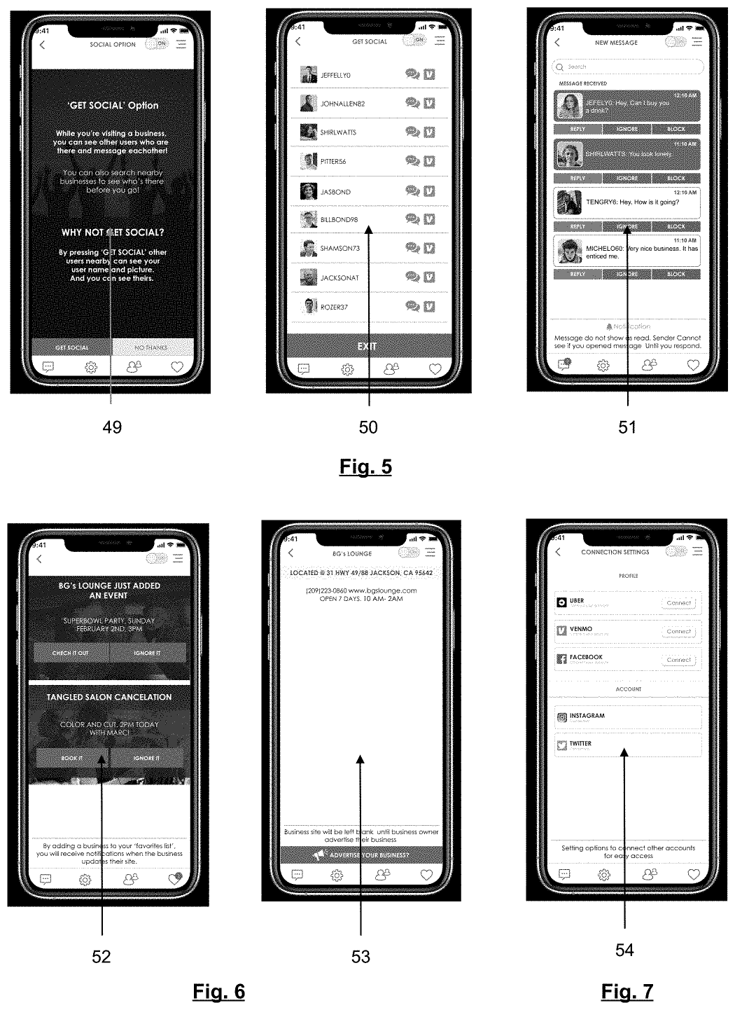

FIG. 5 shows the various social screens for the preferred embodiment of the claimed invention. Social opt-in screen 49 gives the user the option to enable the social functions of the application, thus allowing communication with other users who have created profiles on the system. Social list screen 50 shows a list view of all the users who have enabled social options within the search radius set by the user. The user can view each of these other user's profiles, message them, connect with them on other platforms connected to the application, send electronic payments and various other options. Social message screen 51 displays messages received by the user of the application. These messages include a connection to the social data provided by the sending user including other social networks connected to the application, electronic payment methods such as Venmo and a specific message sent by a user. The receiving user can reply, ignore or block in response to a message from another user.

FIG. 6 shows event pages for the application of the claimed invention. If a user adds a particular business as a favorite, the user will receive notifications about new events scheduled by that business profile. Business event notification screen 52 presents the user with notifications about recently scheduled events by their favorite business profiles. Further, in the preferred embodiment, the business event notification screen 52 can provide updates about newly available appointments due to cancellations. Business event notification detail screen 53 shows expanded details about the business for each notification.

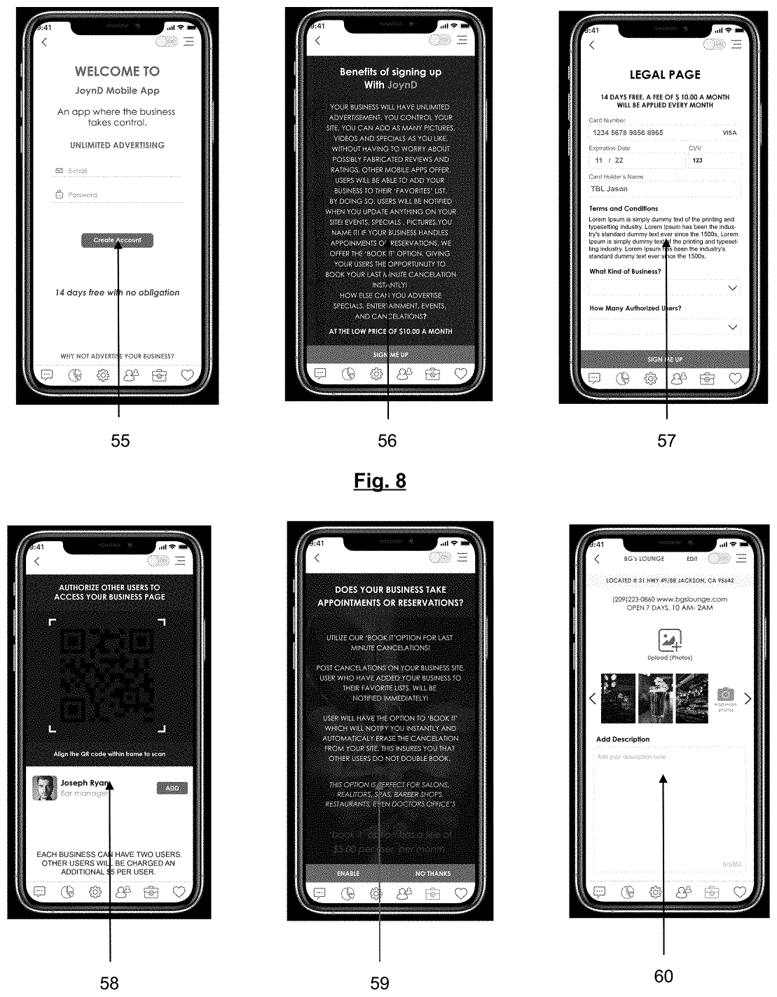

FIG. 7 shows the 3^{rd} party service connection screen 54. In the preferred embodiment of the invention, the user can connect various 3^{rd} party services to their user profile, including Uber, Venmo, Facebook, Instagram and Twitter. These 3^{rd} party services are examples included in the preferred embodiment, but other 3^{rd} party services are anticipated by the claims of the present invention.

FIG. 8 shows the business profile set up screens for the preferred embodiment of the claimed application. Business sign up screen 55 allows a business user to start the process of creating a business profile. Benefits screen 56 describes the benefits of the application to the business user to promote creating a business profile on the platform. Legal page 57 allows the business user to provide credit card information, review the terms and conditions for the platform and provide business information such as the type of business and number of authorized users. Business user authorization screen 58 allows a business user to let other authorized users access their business profile setup. Appointment authorization screen 59 allows a business user to enable appointments or reservations for users. Business profile setup screen 60 allows the business user to provide relevant information about their business including, name, address, phone, website, hours, description, images, videos and other relevant business information.

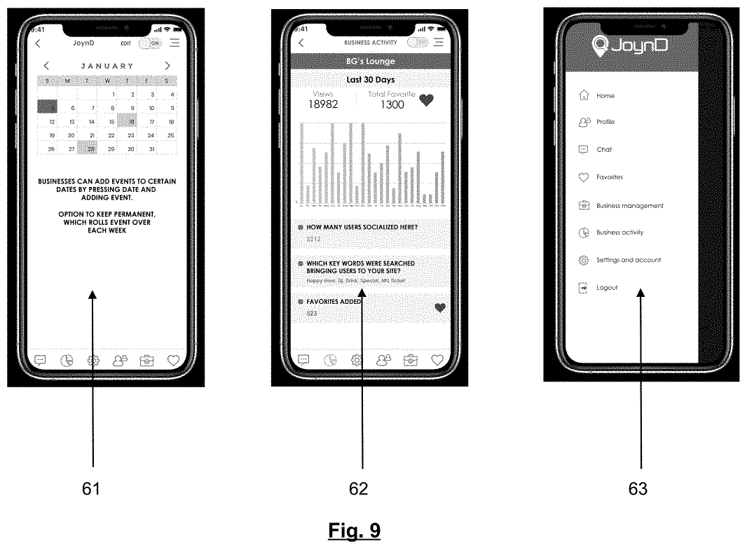

FIG. 9 displays the business profile management and analytics screens for the claimed application. Event scheduling screen 61 allows a business to schedule one time and recurring events to appear on their business profile. Analytics screen 62 gives business insights and analytics about a business profile including views, users who have favorited, users who used social functions while in the business, key words searched to arrive at the business, and views by date. While these are the analytics disclosed in this embodiment, the claims anticipate the provision of many other analytics. Business side menu 63 shows the options available to a business user.

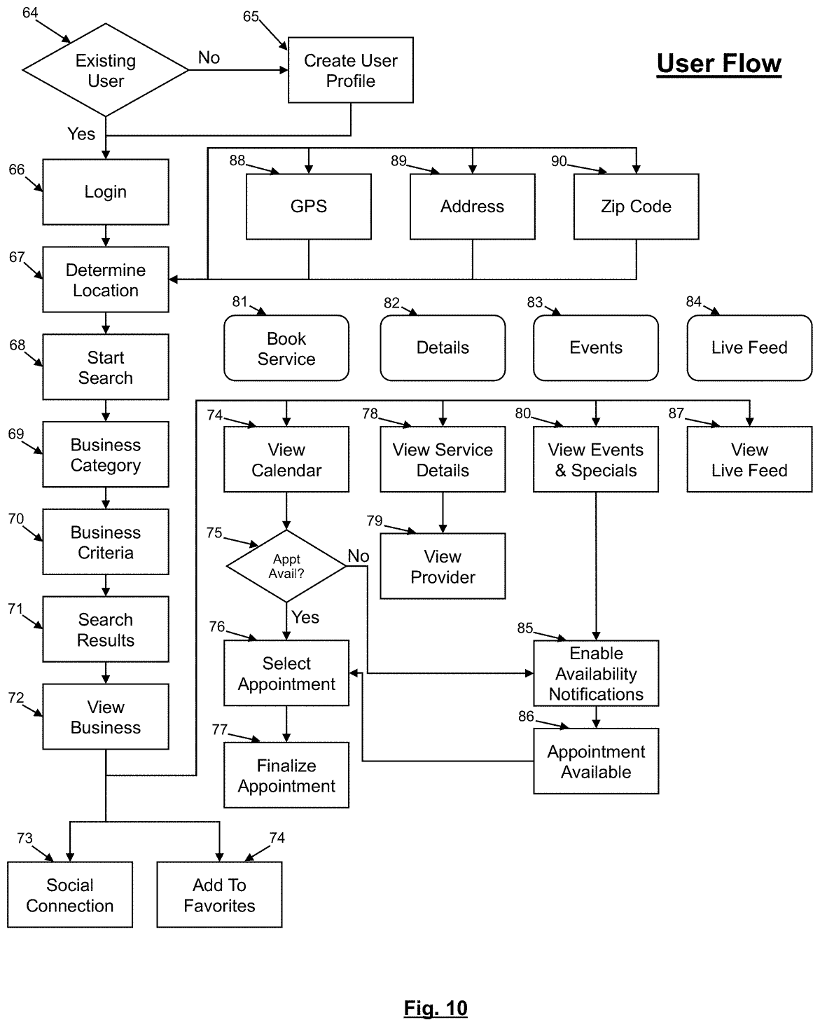

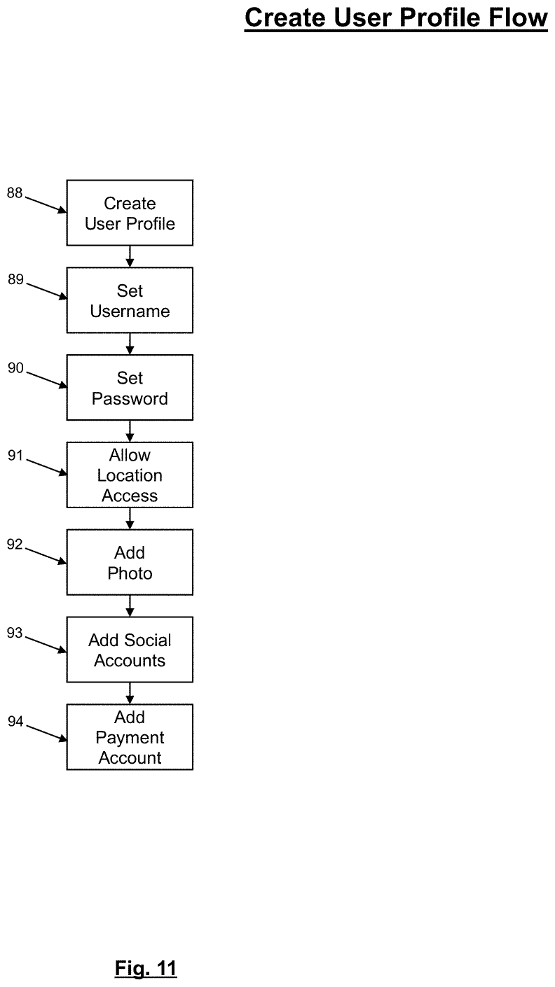

FIG. 10 is a flow chart showing a user searching for and interacting with a business listing. The search process starts at existing user 64, where if the user is an existing user, they proceed to login 66. If they are a new user to the system, they must create a user profile in 65 before then login 66. The user's location is ascertained in determine location 67. If the user has enabled location sharing on their mobile device, location is determined in GPS 88 using GPS latitude and longitude coordinates. If GPS information is not available, or the user wants to complete a search at a different location, the user can provide address 89 or Zip Code 90 for locations for their search. The user begins the search at start search 68. In business category 69, the user selects the category of business to be searched. Available categories in the preferred embodiment include Bakery/Deli, Bar/Club, Barber Shop, Bed & Breakfast, Boutique, Brewery/Winery, Casino, Dentist/Doctor, Grocery, Gym, Hotel, Realtor, Restaurants, Retail and Salon/Spas. While these categories are disclosed in the preferred embodiment, it is anticipated that many other business categories could be included within the scope of the attached claims. Business criteria 70 are selected next which include keywords, location (address, city/state or Zip Code) and search radius. Search results 71 display the businesses identified in the search. View business 72 allows the user to view the details for a specific business identified in the search. From the business detail listing, the user has a variety of options for how to interact with the business.

Social connection 73 allows a user to connect with other users who are located at the same business, provided the other users opt-in to social connections. The user sees a listing of other users who have opted in for social connections and has the ability to send a message or an electronic payment. Users have the ability to read messages, send messages, delete messages, ignore users and block users. Users are also able to set a search radius for other users who are using the social options. Add to favorites 74 allows a user to add a business to their personal list of favorite business for easy location at a later time.

Users also have the ability to follow various other tracks in the platform to book services 81, review business details 81, view events 83 and view live feed 84. If a user chooses the book service track, that user starts at view calendar 74 to view available reservations for the service of their choice. These services include hair cutting/styling/coloring, manicure, pedicure, spa treatments, restaurant reservations, medical or dental appointments and other service appointments offered by the business. Appointment available 75 checks to see if the desired appointment time and service are available for reservation. If the reservation is available, the user selects appointment 76 and finalizes appointment in 77. Finalize appointment 75 completes the booking, takes payment if required, adds the appointment to the user's calendar in the application, and sends appropriate notifications via the mobile operating system, SMS and/or email as configured by the user. If a desired reservation is not available, the user can enable availability notifications 85 to be notified when an available reservation opens up for booking. Notifications can be sent by mobile operating system notification, SMS and/or email based on the user's preferences. When appointment available 85 occurs, the user can then select appointment 76 and finalize appointment 77.

Details 82 track allows the user to review additional and expanded information about the specific business. View service details 79 allows the user to review expanded service details provided by the business. This might include various types of hair appointments including cuts, color and extensions, various spa services, tanning, and other expanded details about business service offerings. View provider 79 allows the user to review details of a specific provider at the business. Providers include hair dressers, manicurists, masseur/masseuses, and other providers that offer services at the business location.

Events 83 track allows the user to review specific events and specials at a business location. View events and specials 80 provides a listing of any upcoming events and specials at a given location. The user can opt to receive notifications of upcoming events and specials in enable availability notifications 85. Live feed 84 track provides access to a live video feed from the business location. If the user chooses view live feed 87, the live feed from the location is displayed on their mobile device or computer screen.

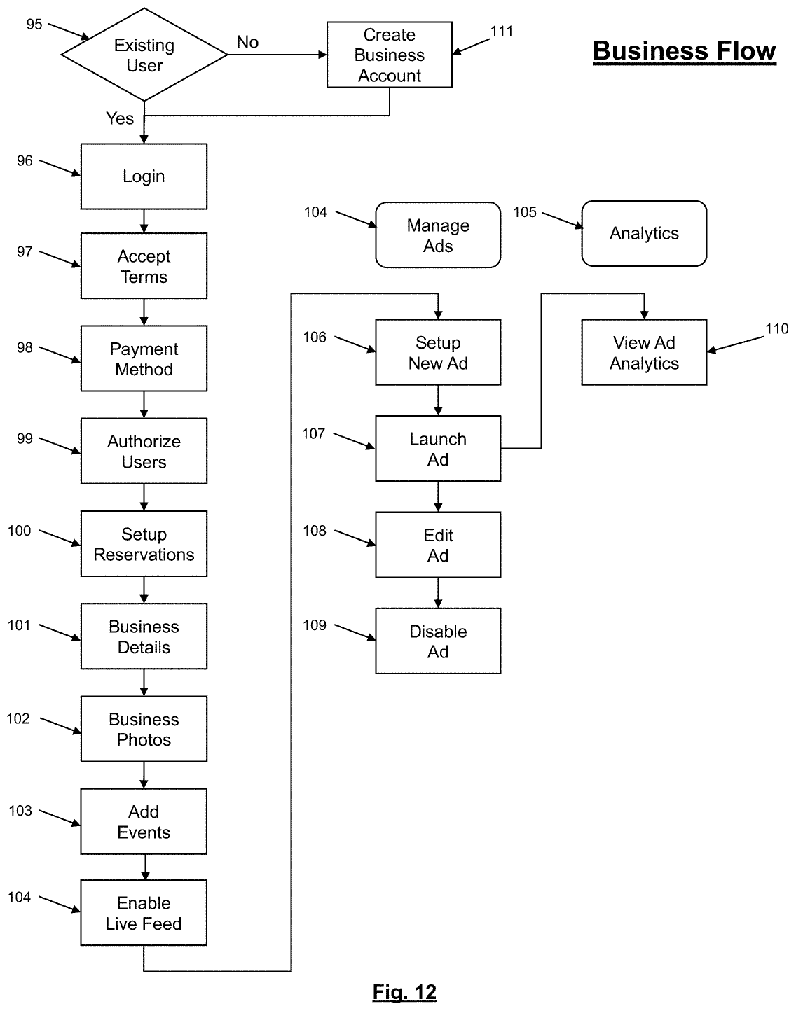

FIG. 11 displays the workflow for the creation of a personal user profile. Create user profile 88 initiates the creation of a new account when the user chooses to sign up using the appropriate button in the application. Set username 89 allows them to set up their preferred username if available in the system. Set password 90 enables the user to set the password to login into their account. Allow location access 91 asks if the application should have access to location data through the mobile device operating system. If the user response affirmatively, the operating system will also prompt the user to allow location access in the operating system settings. Add photo 92 allows the user to add a profile photo and/or other appropriate photos as allowed by the platform. Add social accounts 93 allows the user to connect their social accounts such as Facebook, Twitter and Instagram by either adding their social media user credentials or selecting connection functionality accessing the social media site via an API provided by the social media site. Add payment account 94 allows the user to connect their electronic payment accounts to the platform such as Venmo, Paypal, Cash App and Apple Cash. These electronic payment accounts are connected by either 1) providing appropriate user credentials for the site or 2) using a connection API provided by the electronic payment company.

FIG. 12 shows the workflow to setup a business account for the platform. Existing user 95 determines if the user has an existing account on the platform or not. If no, the user is prompted to create business account 111. Once the account is created, with username and password, the user is prompted to login 96. Accept terms 97 requires the user to read the legal terms of use and privacy statement for the platform and accept them to continue through the process. In payment method 98, the business user must provide credit card information to pay the platform fees for their business account. Authorize users 99 provides a scannable QR code that can be provided to other users to access the business account. This is so employees of the business can also manage the account as the business owner. Setup reservations 100 allows the business user to setup the reservations accepted for services by type of service, available dates/times, providers, costs, and other relevant reservation details. Business details 101 allows the business user to provide the business name, address, phone number, email address, web address, services provided, service providers, and other relevant business details. Business photos 102 allows the business user to upload multiple photos of the business, its location, and various products/services provided at the business. Add events 103 allows the business user to set up events and specials for the business, including integration with the business calendar. Enable live feed 104 allows the business to enable a live video feed from the business location using a connected internet web camera so that personal users can view a live feed of the business. Personal users can utilize this live feed to determine how many other customers are on site at a business to decide to visit the business at that time or a later date.

Business users are given two tracks for additional management of their business account: manage ads 104 and analytics 105. Setup new ad 106 allows the business user to setup a new advertising campaign on the platform. An advertising campaign consists of an advertisement with one or more photos, ad copy, call to action and a destination URL, targeting details, dates and a budget. The platform supports various advertising methods such as cost per click (CPC), cost per action (CPA) and cost per thousand impressions (CPM). Targeting includes keyword and demographic targeting. Budgets can be set by the day, week or month. An advertising campaign always includes a start date and an end date. Launch ad 107 allows the business user to launch the ad campaign setup in setup new ad 106. Here the business user can start, pause or end an advertising campaign. Edit ad 108 allows the user to edit any of the criteria for the advertising campaign including the advertisement, targeting, start/end dates, budget and campaign type. Disable ad 109 allows the business user to disable the campaign completely.

Analytics track 105 allows the business user to view ad analytics for an advertising campaign. Analytics include impressions, clicks, cost per click, budget remaining, conversions, and other key advertising metrics.

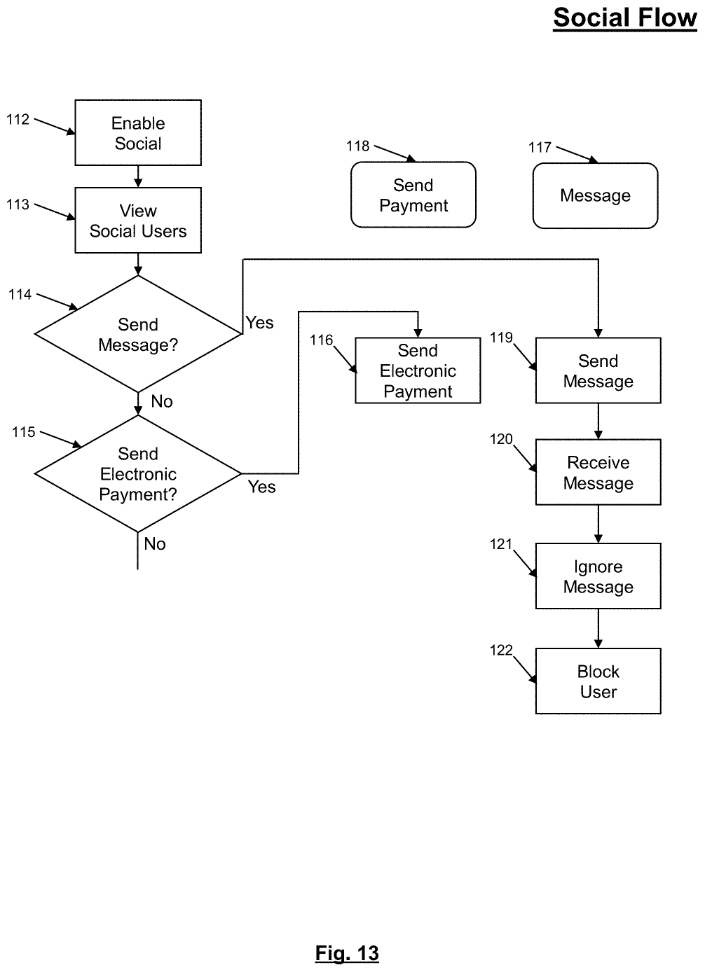

FIG. 13 shows a workflow of the social connection aspects of the present invention. Enable social 112 allows the user to enable social connections with other users in close proximity. As discussed in earlier sections, a personal user can enable a search radius for connecting with other users socially. View social users 113 allows a personal user to view the other personal users within their search radius in a list view arrangement. Send message 114 allows a personal user to send a message to one of the other social users on their social list. Send electronic payment 115 allows a personal user to send electronic payment via their electronic payment provider, such as Venmo, Paypal, Cash App and Apple Cash to other social users.

There are two tracks within the social flow of the present invention: message 117 and send payment 118. Send payment 118 allows the personal user to send a payment via connected electronic payment providers such as Venmo, Paypal, Cash App and Apple Cash to other social users. Message 117 allows personal users to send message 119 to other socially connected users proximity to the personal user. Messages include text and optionally images. Receive messages 120 allows a user to receive and read messages send by other social users. Ignore message 121 allows a personal user to ignore a message from another user without that user seeing that the message has been ignored. Block user 122 allows a user to block another user from communicating with them.

The present figures and detailed description disclose the preferred embodiment of the claimed invention and are not meant to limit the scope of the claims. Many other configurations and embodiments are possible within the scope of the present claims.

The invention claimed is:

1. A method for a personal user to locate a business, purchase a business service and to communicate with other personal users located at the business comprising the steps of:
Creating a business profile for the business, said business profile comprising a business name, a business location, at least one business category, at least one business photo, a business calendar and at least one business service available at the business location;
Creating a personal user profile for the personal user, said personal user profile comprising a username and a personal user calendar;
Connecting at least one social media account of the personal user to the personal user profile;
Connecting at least one electronic payment provider of the personal user to the personal user profile;
Determining the location of the personal user;
Executing a search for a business profile based on a set of search criteria;
Displaying a set of search results of business profiles based on said search criteria;
Selecting a business profile from the set of search results;
Granting communication permission between the personal user and other personal users within a set distance radius;
Sending a message from the personal user to another personal user within the set distance radius; and
Sending an electronic payment from the personal user to another personal user within the set distance radius.

2. The method of claim 1, further comprising the step of:
Viewing a list of events located at the selected business profile.

3. The method of claim 1, further comprising the step of:
Viewing a live video feed from the selected business profile.

4. The method of claim 1, further comprising the step of:
Adding the selected business to a list of favorite locations of the personal user.

5. The method of claim 1, where the set of search criteria comprises one or more of the following:
Business type, business location or keyword.

6. The method of claim 1, further comprising the step of:
Advertising the business profile by promoting the business profile within the set of search results.

7. The method of claim 1, further comprising the steps of:
Viewing by the personal user the business calendar of available business services from the selected business profile;
Reserving a business service from the business calendar of available business services from the selected business profile.

8. The method of claim 1, further comprising the step of:
Enabling a notification if a selected business service becomes available from a selected business profile.

9. The method claim 1, where the social media account is one of the following: Facebook, Twitter or Instagram.

10. The method of claim 1, where the electronic payment provider is one of the following:
Venmo, Cash App, Paypal or Apple Cash.

11. A computer system for a personal user to locate a business, purchase a business service and to communicate with other personal users located at the business comprising:
A computing device comprising:
A processor,
Memory,
Storage for an operating system and applications,
A connection to the internet;
A means for locating the computing device;
An application loaded into the storage on said computing device comprising:
A rendering engine for displaying the application on the computing device;
A means for accessing the location of the personal user from the computing device;
A user interface for the personal user to interact with the application;
A personal user profile for the personal user, said personal user profile comprising a username and a personal user calendar;
At least one social media account of the personal user connected to the personal user profile;
At least one electronic payment provider of the personal user connected to the personal user profile;
Search functionality for searching business profiles on a business database stored on an a server;
A server comprising:
One or more processors,
Memory,
Storage for an operating system, applications and databases,
A connection to the internet;
A database of business profiles stored in the storage, each profile for a said business profile comprising a business name, a business location, at least one business category, at least one business photo, a business calendar and at least one business service available at the business location;
A database of personal user profiles stored in the storage, each profile for a personal user comprising a username and a personal user calendar;
The application configured to:
Determine the location of the personal user;
Execute a search for a business profile based on a set of search criteria;
Display a set of search results of business profiles based on said search criteria;
Select a business profile from the set of search results;
Grant communication permission between the personal user and other personal users within a set distance radius;
Send a message from the personal user to another personal user within the set distance radius; and
Send an electronic payment from the personal user to another personal user within the set distance radius.

12. The computer system of claim 11, the application further configured to:
View a list of events located at the selected business profile.

13. The computer system of claim 11, the application further configured to:
View a live video feed from the selected business profile.

14. The computer system of claim 11, the application further configured to:
Add the selected business to a list of favorite locations of the personal user.

15. The computer system of claim 11, where the set of search criteria comprises one or more of the following:
Business type, business location or keyword.

16. The computer system of claim 11, the application further configured to:
Advertise the business profile by promoting the business profile within the set of search results.

17. The computer system of claim 11, the application further configured to:
View by the personal user the business calendar of available business services from the selected business profile;
Reserve a business service from the business calendar of available business services from the selected business profile.

18. The computer system of claim 11, the application further configured to:
Enable a notification if a selected business service becomes available from a selected business profile.

19. The computer system of claim 11, where the social media account is one of the following: Facebook, Twitter or Instagram.

20. The computer system of claim 11, where the electronic payment provider is one of the following: Venmo, Cash App or Paypal.
